(19) United States
(12) Patent Application Publication
(10) Pub. No.: US 2026/0035961 A1
(43) Pub. Date: Feb. 5, 2026

(54) PRELOAD CAPABLE ELECTRIC DOOR STRIKE ASSEMBLY WITH LOW-POWER AND ADAPTABLE ENERGY CONSUMPTION

(71) Applicant: Hanchett Entry Systems, Inc., Phoenix, AZ (US)

(72) Inventors: Ryan Matthew Sims, Mesa, AZ (US); Joshua T. Peabody, Phoenix, AZ (US); Baruch Spence, Phoenix, AZ (US)

(73) Assignee: Hanchett Entry Systems, Inc., Phoenix, AZ (US)

(21) Appl. No.: 19/269,301

(22) Filed: Jul. 15, 2025

Related U.S. Application Data
(60) Provisional application No. 63/677,513, filed on Jul. 31, 2024.

(51) Int. Cl. E05B 47/00

(52) U.S. Cl. CPC E05B 47/0046; E05B 47/0012

(57) ABSTRACT

A locking mechanism for an electric strike comprises an outer body including first and second openings each including distal edges, and a blocking drum movable between blocking and unblocking positions. The blocking drum includes an outer surface having first and second recesses. First and second blocking members are disposed within the first and second openings, respectively. When the blocking drum is in the blocking position, the first and second blocking members are engaged with the outer surface of the blocking drum, and at least a portion of the first and second blocking members extend outwardly from the respective first and second distal edges to place the electric strike in a locked position. When the blocking drum is in the unblocking position, at least a portion of the first and second blocking members are disposed within the first and second recess, respectively, to place the electric strike in an unlocked position.

### CROSS-REFERENCE TO RELATED APPLICATIONS

This application claims the benefit of U.S. Patent Application No. 63/677,513 filed on Jul. 31, 2024, the contents of which are incorporated by reference in its entirety.

### TECHNICAL FIELD

The present invention relates to an electric door strike assembly for selectively securing a door in a frame; and particularly, to an electric door strike assembly capable of releasing one or more movable keeper assemblies while being placed under a preload force; and more particularly to an electric door strike assembly that is capable of selectively moving the electric door strike assembly between unlocked and locked states while consuming a relative low amount of power and adapting the amount of power required based on the door conditions.

### BACKGROUND OF THE INVENTION

It is common for a door to include a door latch that is selectively secured within a door frame using an electric door strike assembly. In particular, the electric door strike assembly may include a keeper assembly that retains the door latch within a strike cavity. When the door latch is disposed within the strike cavity, it is not unusual for a preload force to be imposed on the keeper assembly by the door latch, thereby making it difficult for the electric strike assembly to move to an unlocked state and allow the door to be opened.

Preload forces imposed on the keeper assembly can be caused by many different factors. For example, when a user approaches a door, the user could pull on the door prior to the keeper assembly being moved to a released position. This force imposed on the keeper assembly can bind the keeper and prevent it from moving to a released position. In other examples, preload forces can also be imposed by mechanical pressure resulting from HVAC systems; door seals; wind pressure imposed on an exterior side of a door; misaligned hardware; warped, damaged, misaligned or poor installation of doors and frames; and pressure differentials that exist within a building. These preload forces can disable proper operation of an electric door strike assembly, particularly those that rely on a solenoid for placing the keeper assembly in an unlocked state, thereby causing the unlock mechanism of the electric door strike assembly to fail and not properly release the door latch from the strike cavity. Failure to release the door latch can prevent a door from opening, thereby hindering safe passage or egress which could create a life-safety issue.

Furthermore, the use of a solenoid in prior art electric strikes typically require a predetermined amount of power in order to move the strike between locked and unlocked states during normal operation of the electric strike. For example, a solenoid may require six watts of power in order to move the electric strike from the locked state to the unlocked state. Given that an electric strike may be used multiple times during a day to allow egress through a door, the cumulative amount of power consumption is significant, particularly in building scenarios where energy conservation is desired. In addition, the solenoid requires the same amount of power to move the electric strike between locked and unlocked states regardless of the conditions in which the door is subjected to.

What is needed in the art is an electric door strike assembly configured to reliably overcome a preload force placed on the keeper assembly by the door latch to allow the door latch to be removed from the electric door strike assembly so that the door can be moved to an opened position. What is also needed is an electric door strike assembly that is capable of operating at lower power levels and adapting its power consumption based on initial and future door opening conditions. It is an aspect of the present invention to provide an electric door strike assembly that fulfills these needs as well as other needs.

### SUMMARY OF THE INVENTION

Briefly described, one exemplary embodiment of a locking mechanism for an electric strike for operating in conjunction with a latch of a lockset is provided. The locking mechanism may comprise an outer body including a first opening and a second opening defined therein, wherein the first opening includes a first distal edge, and wherein the second opening includes a second distal edge. The lock mechanism may further include an actuator, and a blocking drum operably coupled to the actuator, wherein the blocking drum is selectively movable between a blocking position and an unblocking position by the actuator, wherein the blocking drum includes an outer surface, and wherein a first recess and a second recess are defined in the outer surface. A first blocking member is movably disposed within the first opening, and a second blocking member movably disposed within the second opening. When the actuator moves the blocking drum to the blocking position, the first blocking member and the second blocking member are engaged with the outer surface of the blocking drum, at least a portion of the first blocking member extends outwardly from the first distal edge of the first opening, and at least a portion of the second blocking member extends outwardly from the second distal edge of the second opening to place the electric strike in a locked position. When the actuator moves the blocking drum to the unblocking position, at least a portion of the first blocking member is disposed within the first recess of the blocking drum, and at least a portion of the second blocking member is disposed within the second recess of the blocking drum to place the electric strike in an unlocked position.

In another exemplary embodiment an electric strike for operating in conjunction with a latch of a lockset is provided. The electric strike includes the locking mechanism set forth above, and further comprises a housing including an inner wall, wherein the housing defines a housing cavity configured for receiving the latch. The electric strike also includes at least one keeper arm mounted to the housing that is movable between a closed position and an open position. At least one transmission lever is mounted to the housing and moveable between a latched position and an unlatched position, and at least one release trigger is mounted to the housing and is movable between an engaged position and a disengaged position. At least a portion of the first blocking member extends outwardly from the first distal edge of the first opening and engages the inner wall of the housing, and at least a portion of the second blocking member extends outwardly from the second distal edge of the second opening and engages the at least one release trigger to maintain the at least one release trigger in the engaged position which in turn maintains the at least one transmission lever in the latched position and the at least one keeper in the closed position to retain the latch in the housing cavity. When the actuator moves the blocking drum to the unblocking position: at least a portion of the first blocking member is disposed within the first recess of the blocking drum, and at least a portion of the second blocking member is disposed within the second recess of the blocking drum, and the at least one release trigger is permitted to move to the disengaged position and the at least one transmission lever is permitted to move to the unlatched position upon movement of the at least one keeper arm to the open position when the latch is moved out of the housing cavity of the housing.

In yet another exemplary embodiment a method of operating an electric strike for use in conjunction with a latch of a locket is provided. The electric strike defines a cut-out configured for receiving the latch, and the electric includes at least one keeper arm configured for being positioned in a closed position to selectively retain the latch in the housing cavity. The method includes: a) providing a locking mechanism as set forth above; b) providing a first amount of power to the actuator based on a first force applied to the at least one keeper arm to move the blocking drum from the blocking position to the unblocking position to allow the at least one keeper arm to move to the open position and removal of the latch from the housing cavity of the electric strike; and c) providing a second amount of power to the actuator based on a second force applied to the at least one keeper arm to move the blocking drum from the blocking position to the unblocking position to allow the at least one keeper arm to move to the open position and removal of the latch from the housing cavity of the electric strike, wherein the second amount of power is greater than the first amount of power.

In still another exemplary embodiment, a locking mechanism for an electric strike for operating in conjunction with a latch of a lockset is provided. The locking mechanism comprises an outer body including a first opening defined therein, wherein the first opening includes a first distal edge. The locking mechanism further comprises an actuator, and a blocking drum operably coupled to the actuator, wherein the blocking drum is selectively movable between a blocking position and an unblocking position by the actuator, wherein the blocking drum includes an outer surface, and wherein a first recess is defined in the outer surface. A first blocking member is movably disposed within the first opening. When the actuator moves the blocking drum to the blocking position, the first blocking member is engaged with the outer surface of the blocking drum and at least a portion of the first blocking member extends outwardly from the first distal edge of the first opening to place the electric strike in a locked position. When the actuator moves the blocking drum to the unblocking position, at least a portion of the first blocking member is receivable within the first recess of the blocking drum to place the electric strike in an unlocked position.

In a further exemplary embodiment, a locking mechanism for an electric strike for operating in conjunction with a latch of a lockset is provided. The electric strike includes a housing defining a cavity for receiving the latch, and a keeper movably mounted to the housing between a closed position to retain the latch in the cavity and an open position to allow the latch to be removed from the cavity. The locking mechanism comprises an actuator assembly including an actuator and a plunger, wherein a recess is defined in the plunger, and wherein the actuator is configured for moving the plunger between a first position and a second position. The locking mechanism further includes an enclosure including a cut-out defined therein, and a plurality of blocking members disposed in the enclosure, wherein the plurality of blocking members include a first blocking member and a second blocking member. When the plunger is in the first position, the first blocking member is in a blocking position to engage the keeper to maintain the keeper in the closed position. When the plunger is in the second position, the second blocking member is configured for being disposed in the cut-out of the enclosure and the recess of the plunger thereby allowing the first blocking member to move to an unblocking position to define a gap between the first blocking member and a portion of the housing to allow the keeper to move toward the open position.

In still a further exemplary embodiment, a locking mechanism for an electric strike for operating in conjunction with a latch of a lockset is provided. The electric strike includes a housing defining a cavity for receiving the latch, and a keeper movably mounted to the housing between a closed position to retain the latch in the cavity and an open position to allow the latch to be removed from the cavity. The locking mechanism comprises an actuator assembly including an actuator and a plunger, wherein a recess is defined in the plunger, and wherein the actuator is configured for moving the plunger between a first position and a second position. The locking mechanism further includes an enclosure including an outer surface and an end portion, wherein a cut-out is defined in the outer surface. The locking mechanism further includes a plurality of blocking members disposed in the enclosure. For example, the plurality of blocking members may include a first blocking member, a second blocking member, and a third blocking member, wherein the second blocking member may be is disposed between the first blocking member and the third blocking member. When the plunger is in the first position, the first blocking member is in contact with the housing and in a blocking position to engage the keeper to maintain the keeper in the closed position, and the third blocking member is in contact with the end portion of the enclosure. When the plunger is in the second position, the second blocking member is configured for being disposed in the cut-out of the enclosure and the recess of the plunger thereby allowing the first blocking member to move to an unblocking position to define a gap between the first blocking member and a portion of the housing to allow the keeper to move toward the open position.

### BRIEF DESCRIPTION OF THE DRAWINGS

The present invention will now be described, by way of example, with reference to the accompanying drawings, in which:

FIG. 1 is a side view of a door in a secure condition at a first door position within a door frame and having a portion of the door frame broken away to show a prior art electric door strike assembly;

FIG. 2 is an isometric view from the right front showing a prior art electric door strike assembly with the cover removed for clarity (cover is removed and not shown in all views herein);

FIG. 3 is a plan view of one end of the prior art electric door strike assembly shown in FIG. 2 with a portion removed;

FIG. 4 is an isometric view of the prior art electric door strike assembly shown in FIG. 2 with a portion removed;

FIG. 5 is an top perspective view showing an exemplary embodiment of an electric door strike assembly in accordance with the present invention with the cover removed for clarity (cover is removed and not shown in all views herein), wherein one keeper arm is in a closed position and the other keeper arm is in an open position;

FIG. 6 is a perspective view showing an exemplary embodiment of a locking mechanism configured for use with the electric door strike assembly shown in FIG. 5 with the housing shown in phantom;

FIG. 7 is an exploded view of the exemplary locking mechanism shown in FIG. 6;

FIG. 8 is a top perspective view of the exemplary locking mechanism shown in FIG. 6, wherein the locking mechanism is in a blocking position with a top cover removed;

FIG. 9 is a left side perspective view of the exemplary locking mechanism shown in FIG. 6;

FIG. 10 is a plan view the exemplary locking mechanism shown in FIG. 6 included in the electric door strike assembly shown in FIG. 5;

FIG. 11A is a plan view similar to FIG. 10 with the top cover of the locking mechanism removed, and the locking mechanism shown in the blocking position;

FIG. 11B is a plan view similar to FIG. 11A showing the locking mechanism shown in an unblocking position and the keeper arm in a closed position

FIG. 11C is a plan view similar to FIGS. 11A and 11B showing the locking mechanism shown in an unblocking position and the keeper arm in an open position;

FIG. 12 is a cross-sectional view of the exemplary locking mechanism taken along line 12-12 in FIG. 10 showing the load distribution across the locking mechanism due to application of a preload force;

FIG. 13 is a cross-sectional view of an exemplary alternative embodiment of a locking mechanism that may be used in conjunction with the electric door strike assembly shown in FIG. 5;

FIG. 14 is a perspective view of another embodiment of an electric door strike assembly in accordance with other aspects of the present invention;

FIG. 15 is a perspective view of the electric door strike assembly shown in FIG. 14 with a portion of the housing removed and certain portions shown in phantom;

FIG. 16 is a top view of the electric door strike assembly shown in FIG. 14 with the actuator assembly removed and certain portions shown in phantom;

FIG. 17 is an enlarged portion of the electric door strike assembly shown in FIG. 14;

FIG. 18A is a portion of the electric door strike assembly shown in FIG. 14 with certain portions removed showing the actuator assembly in a first position and a blocking assembly in a blocking position to maintain a keeper in a closed position;

FIG. 18B is a view similar to FIG. 18B showing the actuator assembly in the second position to allow the blocking assembly to move to an unblocking state; and

FIG. 18C is a view similar to FIG. 18C showing the blocking assembly in the unblocking state when the keeper is moved to an open position.

Corresponding reference characters indicate corresponding parts throughout the several views. The exemplifications set out herein illustrate currently preferred embodiments of the invention, and such exemplifications are not to be construed as limiting the scope of the invention in any manner.

### DESCRIPTION OF THE PREFERRED EMBODIMENTS

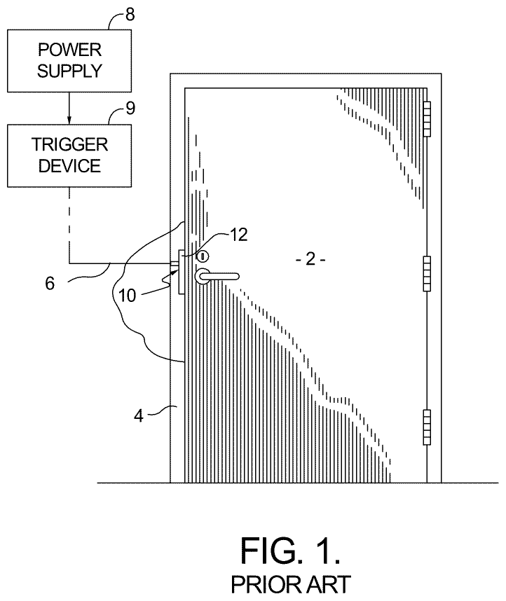

Referring to FIG. 1, a typical door 2 is shown in a first, or closed, position. A lock device, such as, but not limited to, a prior art electric door strike assembly 10, known as an electric strike, may be mounted to a surface of a mounting structure 4 (such as, but not limited to, a door jamb), or positioned within a recess defined in mounting structure 4. As will be further described below, electric door strike assembly 10 includes a housing 12, which is configured to accommodate electrical and mechanical components thereof. The electrical components in turn may be electrically in communication by means of wiring 6. Electric door strike assembly 10, for example, may be in communication with a power supply 8 such as, for example, battery power or a 12 or 24 volt circuit, which in turn may be hardwired to the external electric power grid where power supply 8 is configured to receive 115 VAC or 230 VAC line voltage. Electric door strike assembly 10 may be activated via a trigger device, such as a credential or authentication device 9. This credential device 9 is typically a switch whose contacts selectively actuate electric door strike assembly 10. The credential device 9, however, is often incorporated into a control entry device such as a card reader or digital entry keypad, where the actuator is activated after an authorized card is presented to the card reader (or an authorized code is entered into credential device 9). For example purposes, door 2 may be pivotally mounted so that door 2 is able to move between a closed position and an open position.

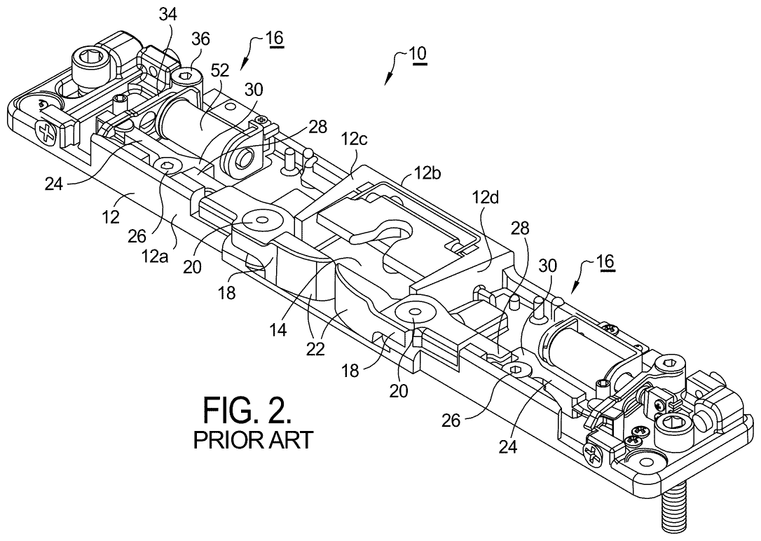

Referring now to FIGS. 2-4, electric door strike assembly 10 comprises housing 12 mountable to door frame 4. The electric door strike assembly 10 is to be regarded as exemplary in nature and does not serve to limit application of the present invention to embodiments solely thereto. The mounting of housing 12 may be either surface mounted or recessed mounted relative to the door frame, as is well known in the prior art. A cover (not shown) may be mounted to housing 10 to protect the components disposed within housing 12 from tampering as well as from dirt, dust, metal particles that are formed during the operation of strike 10, and the like. Housing 12 includes an opening or cutout portion 14 adapted to receive a door latch associated with a door that is configured for being disposed in the door frame. Cutout portion 14 may be generally defined by a rear wall 12b and opposing side walls 12c, 12d formed in housing 12.

The referenced electric door strike assembly 10 shown in FIG. 2 may comprise first and second mirror-image locking mechanisms 16 mounted to housing 12 that may be disposed symmetrically about cutout portion 14. For simplicity and clarity in presentation, general reference may be made to only one of the two mirror-image mechanisms 16, but such reference should be considered as being equally applicable to both except as otherwise noted.

Electric door strike assembly 10 includes a pair of keeper arms 18 that are mounted to housing 12 at keeper arm pivots 20 positioned proximate the midpoint of keeper arms 18, and keeper arms 18 are positioned proximate to cutout portion 14. When keeper arms 18 are oriented in a closed position where their longitudinal axes are aligned in a plane generally parallel to the plane created by front wall 12a of housing 12 (FIGS. 2-4), latch portions 22 of keeper arms 18 extend into and occlude cutout portion 14 thereby retaining the door latch within cutout portion 14. As is known in the prior art, when the door is moved to a closed position within the door frame, the keeper arms 18 may remain in the closed position so that the door latch contacts latch portions 22 and moves into a retracted position. After the door latch clears keeper arms 18, the door latch a door latch spring biases the door latch toward an extended position into cutout portion 14 to place the door in a locked position in the door frame. That is, when the door is shut into the door frame supporting strike assembly 10, the door latch retracts to allow passage past latch portions 22 but then snaps into cutout portion 14. Once the door latch is positioned in cutout portion 14 and keeper arms 18 are in a closed position, the door latch is trapped in cutout portion 14 and the door cannot be opened.

Each keeper arm 18 is adapted to engage a respective transmission lever 24 mounted to housing 12 to selectively retain such keeper arm 18 in the closed position. Transmission lever 24 is pivotally coupled to housing 12 via a transmission lever pivot 26. The axes of rotation of transmission lever pivot 26 is parallel to the axes of keeper arm pivot 20 associated with the respective keeper arm 18. Keeper arm 18 includes a prong 28 that is positioned opposite of latch portion 22. Prong 28 is configured for being received within a fork 30 positioned on a corresponding end of transmission lever 24 when keeper arm 18 is in the locked position.

Each keeper arm 18 is resiliently urged to the closed position by a spring (not visible) which may be mounted on keeper arm pivot 20. One arm of each spring may engage keeper arm 18 on its prong side and the other arm of the spring may engage side wall 12c, 12d. Thus, when prong 28 is released from fork 30, keeper arm 18 is held in the closed position only by the springs. To open the door, a user simply applies a force to the door in a door opening direction, causing the door latch to rotate one or more of keeper arms 18 against the bias imposed on keeper arms 18 by springs. Once the door latch clears keeper arms 18, keeper arms 18 rotate back to the closed position under the urging of the springs. Further, to best position each transmission lever 24 to receive prong 28, one end of a compression spring (not shown) may be mounted to fork 30 and at the other end thereof to housing 12 proximate fork 30. The compression spring urges transmission lever 24 rotatably away from housing 12 to position fork 30 to receive prong 28.

A release lever 34 is used to control the motion of each transmission lever 24 from a locked state to a rotatable state. Release lever 34 is mounted at one end thereof to housing 12 by release lever pivot 36. The axis of rotation of release lever pivot 36 is parallel to but offset laterally from the respective axes of both keeper arm pivots 20 and transmission lever pivots 26. The other end of release lever 34 engages an end 38 of transmission lever 24 opposite fork 30. A solenoid 52, when energized, may operate in a fail-secure mode to rotate release lever 34 about release lever pivot 36 to disengage end 38 of transmission lever 24, thereby unlocking transmission lever 24 to allow keeper arm 18 to rotate about keeper arm pivot 20 from a latch-blocking position when a force is exerted by the extended door latch as the door is opened. In the alternative, solenoid 52 may operate in a fail-safe mode to rotate release lever 34 about release lever pivot 36 to engage end 38 of transmission lever 24, thereby preventing the transmission lever 24 from rotating about keeper arm pivot 20 and placing the keeper arm 18 in the latch-blocking position. In either case, a typical amount of power required for solenoid 52 to move release lever 34 is six watts. The conjunctive operation of the solenoid, release lever, transmission lever and keeper arm is fully described in U.S. Pat. No. 8,454,063, the entirety of which is incorporated herein by reference, and need not be described in further detail here.

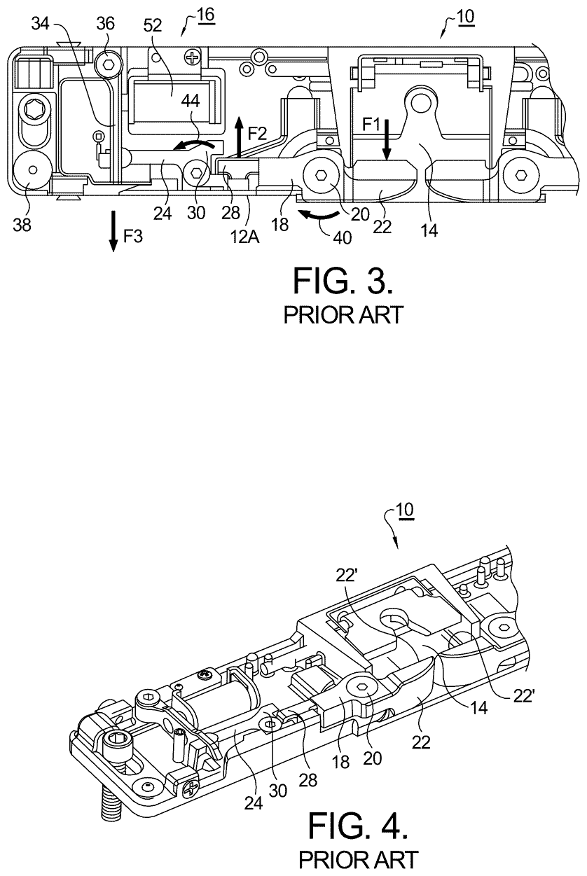

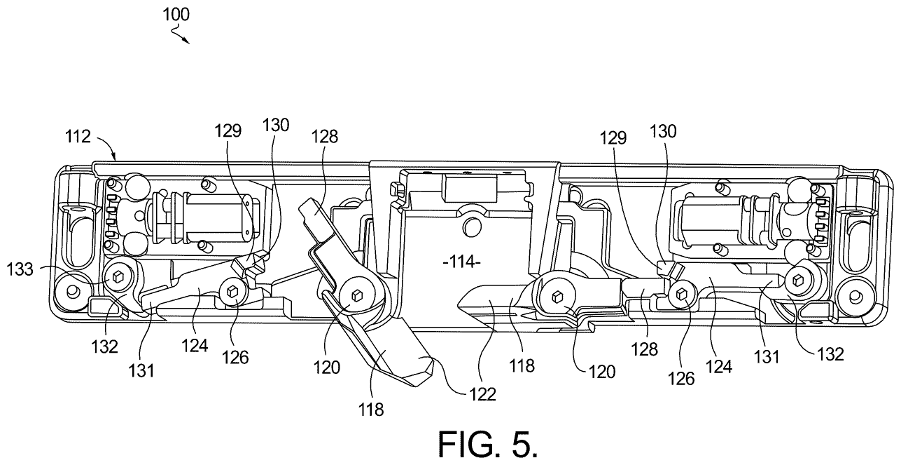

In the prior art electric door strike assembly 10 described above, and as shown in FIGS. 3 and 4, a preload force F1 may be applied to an inner face 22′ of latch portion 22 of keeper arms 18 by a door latch disposed within cutout portion 14. The preload force F1 can be imposed by a user pre-maturely pulling on the door when the electric strike 10 is still in a locked mode, or when the door is subject to a stacking pressure, for example. The preload force F1 results in a torque 40 being imposed on keeper arm 18, which in turn causes prong 28 to impose a preload force F2 on an inner surface 42 of fork 30 of transmission lever 24. The resulting force F2 imposes a torque 44 on transmission lever 24, which in turn causes transmission lever 24 to impose a preload force F3 on release lever 34. In some instances, this preload force F3 may be large enough wherein the constant six watt power output of solenoid 52 is unable to rotate release lever 34 about release lever pivot 36. In this case, keeper arm 18 will not be able to be released by transmission lever 24 and electric strike 10 will be bound in its unlocked state. This can create an undesirable and possibly dangerous situation if a user is unable to release the door latch from the housing cavity 14 in an emergency. One potential option to address this situation is to provide solenoid 52 with a constant amount of power that is greater than the standard six watts of power in an attempt to overcome the preload force F3, but this solution may result in not only an electric strike that is less energy efficient, but also unwanted increase in wear and tear on the physical components within electric strike 10 which could lead to solenoid damage and keeper failure.

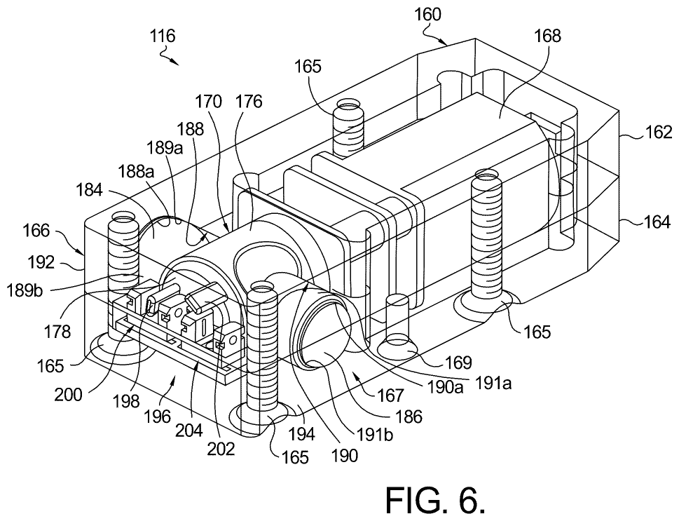

Referring now to FIG. 5, an exemplary embodiment of an electric door strike assembly 100 in accordance with certain aspects of the present invention is shown. Electric door strike assembly 100 may include at least one keeper arm 118 that is rotatably coupled with a housing 112 about a respective keeper arm pivot 120. As can be seen in FIG. 5, for example, electric door strike assembly 100 may include two keeper arms, but it should be understood that the present invention also may be implemented in an electric strike that includes one keeper arm. Keeper arm 118 is configured for moving between a closed position and an open position to selectively retain a door latch in a housing cavity 114 within housing 112. Keeper arm 118 includes a latch portion 122 adapted to occlude cutout portion 114 when in the closed position to selectively retain the door latch therein. The opposing end of keeper arm 118 includes a prong 128 configured to be releasably received within a forked end 130 of a respective transmission lever 124 to retain keeper arm 118 in the closed position. Further, a spring (not shown) is associated with keeper arm 118 and operates to bias keeper arm 118 to the closed position.

Transmission lever 124 is rotatably coupled with housing 112 about a transmission lever pivot 126. An axis of rotation of transmission lever pivot 126 may be offset and parallel with an axis of rotation of keeper arm pivot 120. Transmission lever 124 is configured for moving between a latched position to retain the keeper arm 118 in the closed position, and an unlatched position to allow keeper arm 118 to move to the open position. Transmission lever 124 includes forked end 130 and a distal end 131, wherein transmission lever pivot 126 may be disposed between distal end 131 and forked end 130. A spring (not shown) is engaged with a portion 129 of transmission lever 124 and is configured for biasing transmission lever 124 to the unlatched position so that forked end 130 of transmission lever 124 is in a position to receiver prong 128 of keeper arm 118 when moving from the open position to the closed position. Distal end 131 of transmission lever is configured for engaging a release trigger 132.

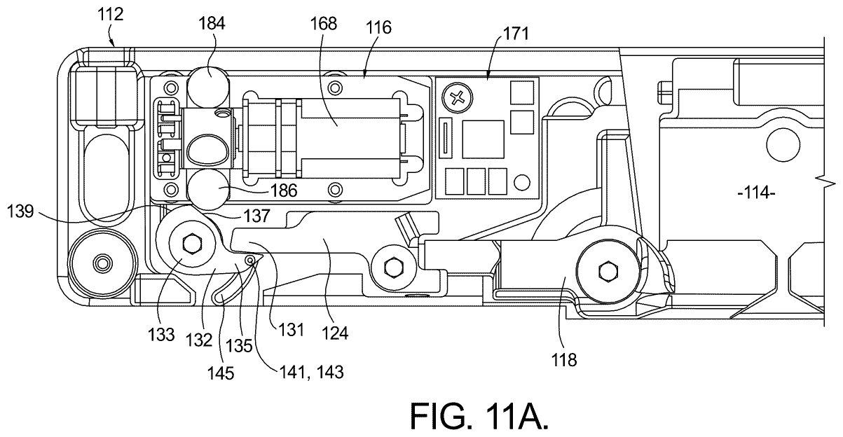

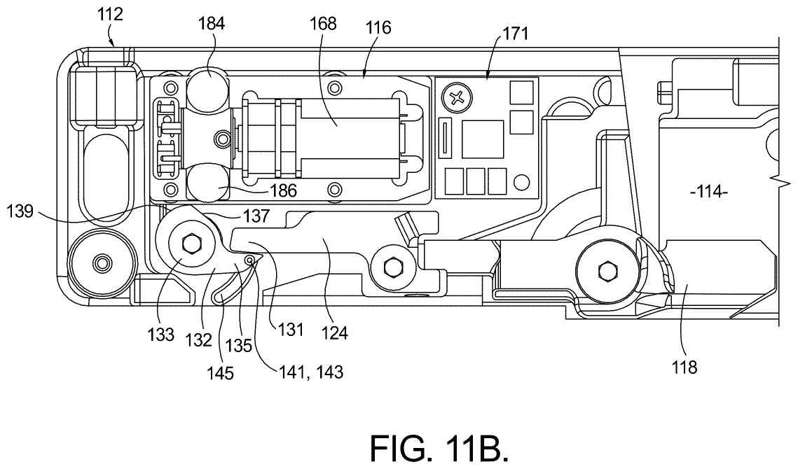

With additional reference to FIGS. 10, 11A, 11B and 11C, release trigger 132 is rotatably coupled with housing 112 about a release trigger pivot 133, and includes an arm 135 that engages distal end 131 of transmission lever 124. Arm 135 includes a pin 141 extending from opposite sides of release trigger 132 in a direction that is parallel with release trigger pivot 133. A first end 143 of pin 141 is engaged with a spring (not shown) that operates to bias release trigger 132 to an engaged position (FIG. 10, 11A, 11B). A second end (not shown) of pin 141 is movably disposed in a slot 145, such as an arcuate slot, that may be defined in a wall of housing 112, which limits the rotational travel of release trigger 132 between a disengaged position (FIG. 11C) and the engaged position.

Release trigger 132 further includes a locking surface 137 and a cam surface 139. Locking surface 137 is configured for engaging a respective locking mechanism 116 to maintain release trigger 132 in the engaged position, and thereby hold transmission lever 124 in the latched position and keeper arm 118 in the closed position. In an exemplary embodiment, locking surface 137 may be a generally planar surface. Cam surface 139 may be disposed adjacent to locking surface 137, and allows release trigger 132 to rotate about release trigger pivot 133 and move to the disengaged position with respect to locking mechanism 116. When release trigger 132 rotates to the disengaged position, transmission lever 124 moves to the unlatched position and keeper arm 118 is permitted to move to the open position when the door latch is removed from housing cavity 114.

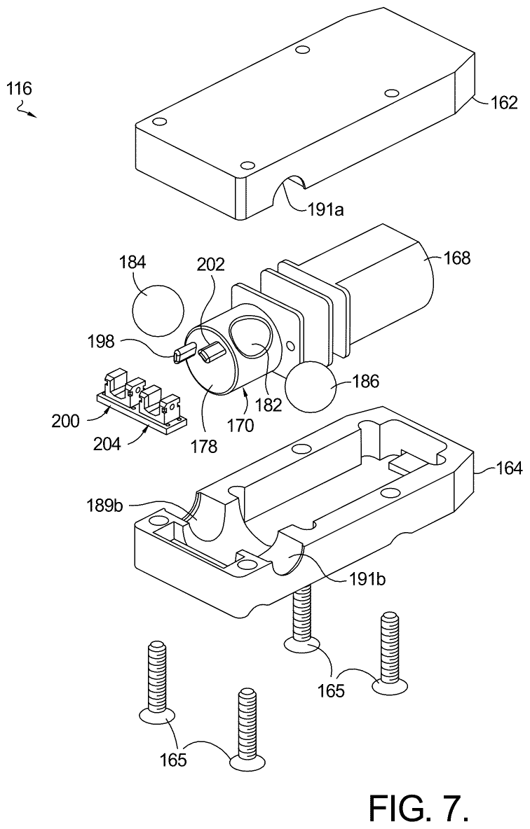

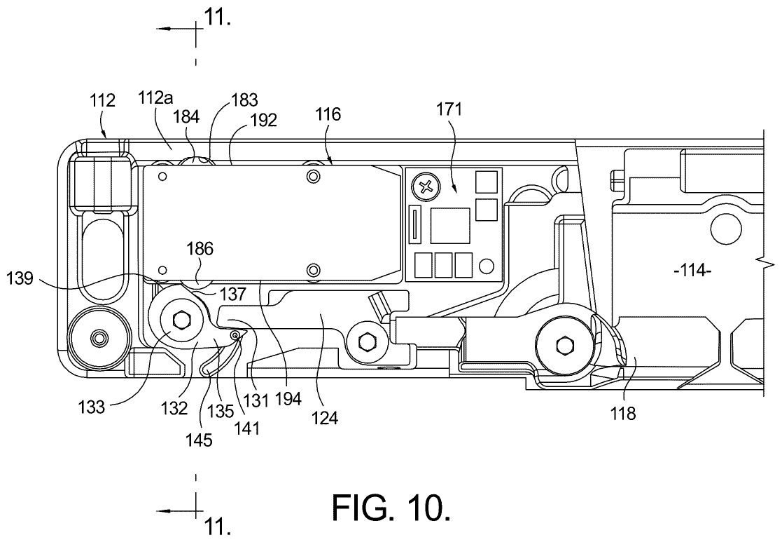

Turning now to FIGS. 6-9, an exemplary embodiment of locking mechanism 116 in accordance with an aspect of the present invention is provided. Locking mechanism 116 may comprise an outer body 160 configured for receiving at least a portion of the operational components of locking mechanism 116. For example, outer body 160 may be a clam shell configuration including a first piece 162 and a second piece 164 that operate to at least partially enclose the operational components of locking mechanism 116. First and second pieces 162, 164 may be joined together using one or more fasteners 165, and outer body 160 may further be fastened to housing 112 of electric door strike assembly 100 using a fastener 169. In this aspect, locking mechanism 116 to be a modular component that can be separately installed and/or replaced. In another aspect, it should be understood that at least one of first and second pieces 162, 164 may be integrally formed with housing 112 of electric door strike assembly 100. In either case, outer body 160 may include two opposing side walls 166, 167, wherein one of the side walls 166 is configured for being positioned adjacent to an inner surface of a back wall 112a (FIG. 5) of housing 112 of electric door strike assembly 100.

Locking mechanism 116 may further include an actuator, such as a gear motor 168, that is operationally coupled to a blocking drum 170, whereby blocking drum 170 is selectively positionable between a blocking position and an unblocking position, as will be described in greater detail below. When power is selectively provided to actuator 168 via a control module 171 (FIGS. 11A-11C), actuator 168 is configured to cause blocking drum 170 to selectively rotate in a first rotational direction and a second rotational direction about an axis of rotation 172 of a shaft 174. In one exemplary embodiment, motor 168 has a power output rating sufficiently high enough to rotate blocking drum 170 even when electric door strike assembly 100 is subject to a preload force of about 15 pounds, and more preferably greater than about 25 pounds.

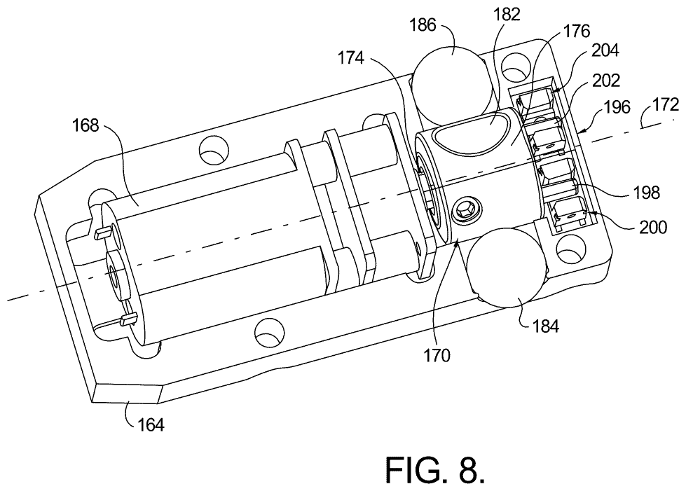

Blocking drum 170 is rotationally disposed within housing 160 and includes an outer surface 176 and an end surface 178. Outer surface 176 may be cylindrically-shaped and include two recesses 180, 182 defined therein. Recesses 180, 182 are configured for selectively receiving at least a portion of a respective blocking member 184, 186 when blocking drum 170 is in the unblocking position (FIG. 11B). With continued reference to FIGS. 6-9, side walls 166, 167 of outer body 160 both have a respective opening 188, 190 defined therein. It should be understood that if outer body 160 is formed in a clam shell configuration including first piece 162 and a second piece 164, the each opening 188, 190 may be formed by a combination of corresponding cut-outs 189a, 189b, 191a, 191b (FIGS. 6 and 7). Each opening 188, 190 is dimensioned to receive a respective blocking member 184, 186, wherein a portion of each blocking member 184, 186 extends outwardly beyond an external surface 192, 194 of its respective side wall 166, 167 when blocking drum 170 is in the blocking position (FIGS. 6, 8, 9, 10, 11A, 12). Given that side wall 166 is configured for being positioned adjacent to an inner surface of a back wall 112a (FIG. 5) of housing 112 of electric door strike assembly 100, blocking member 184 will be placed into engagement with back wall 112a of housing 112 when blocking drum 170 is in the blocking position, as will be discussed in more detail below. Back wall 112a may define a recess 183 (FIG. 10) for receiving at least a portion of blocking member 184 for assisting with maintaining blocking member 184 in proper position when blocking drum 170 is in the blocking and unblocking positions. In an exemplary alternative embodiment, it should be understood that recess 180 may be omitted from blocking drum 170.

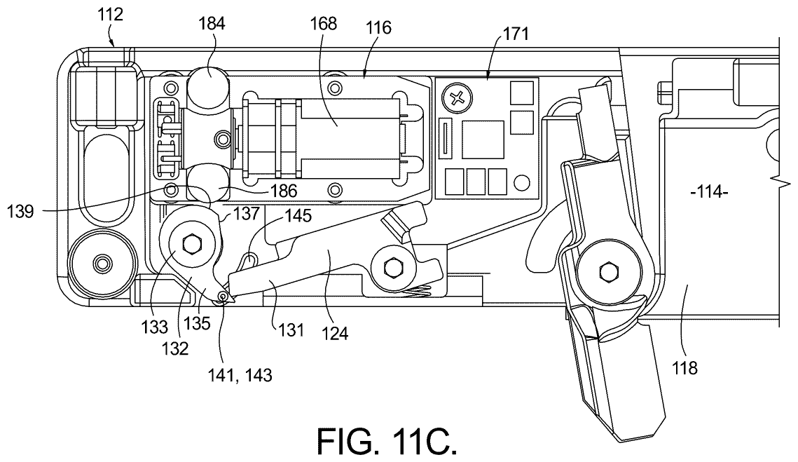

In one exemplary embodiment, as seen in FIGS. 6, 7, 11A, 11B, 11C and 11, blocking members 184, 186 may be ball bearings dimensioned to freely move within respective openings 188, 190 defined in housing 116. In order to retain blocking members 184, 186 within outer body 160 while at the same time allowing a portion of blocking members 184, 186 to extend beyond external surfaces 192, 194 of side walls 166, 167, it should be understood that a diameter of an distal edge 188a, 190a of openings 188, 190 may be smaller than a diameter of blocking members 184, 186. With specific reference to FIG. 12, the respective center points 184a, 186a of blocking members 184, 186 may be co-planar with the axis of rotation 172 of blocking drum 170. In other words, center points 184a, 186a may be aligned with the axis of rotation 172 of blocking drum 170.

Locking mechanism 116 may further include a position monitor system 196 that operates to determine when blocking drum 170 is in at least one of the blocking and unblocking positions. In one exemplary embodiment, position monitor system 196 may include a first arm 198 extending from end surface 178 of blocking drum 170 and off-set a distance from axis of rotation 172. Position monitor system 196 further includes a first sensor 200 that is configured for sending a signal to control module 171 when first arm 198 is disposed adjacent to first sensor 200 that is representative of one of the blocking or unblocking positions. In another embodiment, position monitor system 196 may further include a second arm 202 extending from end surface 178 of blocking drum 170, off-set a distance from axis of rotation 172, and radially spaced apart from first arm 198. In the instance that second arm 202 is included in position monitor system 196, position monitor system 196 may further include a second sensor 204 that is configured for sending a signal to control module 171 when second arm 202 is disposed adjacent to second sensor 204 that is representative of the other of the blocking or unblocking positions.

In an exemplary embodiment, at least one of first and/or second sensors 200, 204 may be an optical sensor that is configured for generating an optical beam of light. When the beam of light is interrupted by the respective first or second arms 198, 202, the respective signal is sent to control module 171 to indicate that blocking drum 170 is in the respective blocking or unblocking position. For instance, if first arm 198 interrupts the optical beam generated by first sensor 200, then a signal may be sent to control module 171 indicating that blocking drum 170 is in the blocking position. If second arm 202 interrupts the optical beam generated by second sensor 204, then a signal may be sent to control module 171 indicating that blocking drum 170 is in the unblocking position.

Having described the components of electric door strike assembly 100, the operation thereof will now be described with reference to FIGS. 10, 11A, 11B, 11C and 11. With initial reference to FIGS. 10 and 11A, electric door strike assembly 100 is shown in a locked state, wherein a door latch may be retained in housing cavity 114 to secure a door in a door frame. In the locked state, keeper arm 118 is positioned in the closed position such that latch portion 122 occludes the opening in housing cavity 114, and prong 128 is disposed in forked end 130 of transmission lever 124. Transmission lever 124 is in turn disposed in the latched position wherein distal end 131 is engaged with arm 135 of release trigger 132. Release trigger 132 is in the engaged position wherein its locking surface 137 is in contact with locking mechanism 116. With specific reference to FIG. 11A, blocking drum 170 of locking mechanism 116 is in the blocking position, whereby both blocking members 184, 186 are engaged with outer surface 176 of blocking drum 170 at opposite contact points 206a, 206b of blocking drum 170. As seen in FIG. 12, contact points 206a, 206b may be co-planar with the axis of rotation 172 of blocking drum 170. Given that blocking member 186 is engaged with outer surface 176 of blocking drum 170, blocking member 186 is positioned such that it extends outwardly from opening 190 and into engagement with locking surface 137 of release trigger at a contact point 208. Contact point 208 may be co-planar with contact points 206a, 206 and the axis of rotation 172 of blocking drum 170. Further, blocking member 184 is engaged with outer surface 176 of blocking drum 170 and blocking member 184 and therefore extends outwardly from opening 188 and into engagement with back wall 112a of housing 112 at a contact point 210. Contact point 210 may be co-planar with the contact points 206a, 206 and the axis of rotation 172 of blocking drum 170, and may be co-planar with contact point 208.

With the electric door strike assembly 100 in the locked state shown in FIGS. 10, 11A and 12, a preload force 212 may be imposed on keeper arm 118, which will result in a force 214 being imposed on forked end 130 of transmission lever 124. In turn, distal end 131 of transmission lever will thereafter impose a force 216 on arm 135 of release trigger 132. With specific reference to FIGS. 10 and 12, due to contact between locking surface 137 and blocking member 186 at point 208, a force 218 will be transmitted through locking mechanism 116 to back wall 112a of housing 112 in accordance with an aspect of the present invention. In particular, force 218 is directed from point 208, through contact points 206a, 206b and to back wall 112a of housing 112 at contact point 210. As can be seen in FIG. 12, force 218 is directed through the axis of rotation 172 of blocking drum 170 as it is transmitted from release trigger 132 to back wall 112a of housing 112. In an exemplary embodiment where blocking members 184, 186 are ball bearings, force 218 may also be transmitted along a path that is coplanar with respective center points 184a, 186a. By allowing preload force 212, via forces 214, 216, 218, to pass through axis of rotation 172 of blocking drum 170 to back wall 112a of housing 112, locking mechanism 116 provides a robust solution for resisting preload force 212 without imposing undue stress and wear on the components of electric door strike assembly 100.

As seen in the sequence of FIGS. 11A, 11B and 11C, electric door strike assembly 100 may be moved from the locked state to an unlocked state to allow a door latch to be removed from housing cavity 114. The movement of electric door strike assembly 110 from the locked state to the unlocked state may be initiated at least in part by control module 171. Control module 171 may be disposed within housing 112 and electrically connected to power supply 8 and authentication device 9. For example, authentication device 9 may be one or more of a keypad, swipe card, card reader, or biometric sensor. In a secured setting, authentication device 9 may be provided whereby control module 171 sends motor 168 a signal to move electric door strike assembly 100 to the unlocked state only upon input of proper access credentials at authentication device 9. It should also be understood that control module 171 may be external to electric door strike assembly 100, and be optionally integrated within authentication device 9.

When electric door strike assembly 100 is to be moved to the unlocked state, control module 171 may send an unlock signal to motor 168 so that power is provided to motor 168 to rotate blocking drum 170 in the first rotational direction about the axis of rotation 172. As seen in the sequence of FIG. 11A to FIG. 11B, the rotation of blocking drum 170 may continue until second arm 202 extending from blocking drum 170 is in a position where it is sensed by second sensor 204. At that point, blocking drum 170 is in the unblocking position where at least a portion of blocking members 184, 186 are able to be positioned within recesses 180, 182, respectively. This allows blocking members 184, 186 to move inwardly within openings 188, 190, respectively, toward blocking drum 170. With blocking member 186 able to move within recess 182 toward blocking drum 170, blocking member 186 may disengage from locking surface 137 of release trigger 132, and thereby allow release trigger 132 to rotate about release trigger pivot 133. However, due to the spring bias imposed on release trigger 132 toward the engaged position, and the spring bias imposed on keeper arm 118 toward the closed position, transmission lever 124 will remain in the position shown in FIG. 11B until a door latch contacts keeper arm 118 as it is moved out of housing cavity 114 so that door latch rotates keeper arm 118 about keeper pivot 120 to the position in FIG. 11C. Once this happens, prong 128 of keeper arm 118 is removed from forked end 130 of transmission lever 124, and the spring bias on transmission lever 124 operates to rotate transmission lever 124 about transmission lever pivot 126. Distal end 131 of transmission lever 124 then operates to rotate release trigger 132 to the disengaged position through engagement with arm 135. When release trigger 132 is in the disengaged position shown in FIG. 11C, blocking member 186 is able to contact cam surface 139. After the door latch is removed from housing cavity 114, keeper arm 118 is biased back into the closed position, which in turn moves transmission lever 124 and release trigger 132, as seen in FIG. 11B.

As seen in the sequence of FIGS. 11B and 11A, electric door strike assembly 100 may be moved from the unlocked state back to maintain keeper arm 118 in the closed position. The movement of electric door strike assembly 110 from the unlocked state to the locked state may be initiated at least in part by control module 171. Control module 171 could operate on a timer, wherein after a predetermined period of time, a lock signal is communicated to motor 168. In another exemplary embodiment, control module 171 could wait for the input of proper access credentials into authentication device 9 to provide the lock signal. In either case, once the lock signal is provided to motor 168, power is provided to motor 168 to rotate blocking drum 170 in the second rotational direction about the axis of rotation 172. The rotation of blocking drum 170 may continue until first arm 198 extending from blocking drum 170 is in a position where it is sensed by first sensor 200. At that point, blocking drum 170 has returned to the blocking position shown in FIGS. 6, 8, 9, 11A and 12 where blocking member 186 is engaged between locking surface 137 of release trigger 132 and outer surface 176 of blocking drum 170 at points 208, 206a, and blocking member 184 is engaged between outer surface 176 of blocking drum 170 and back wall 112a at points 206b, 210.

In accordance with the present invention, the use of blocking members 184, 186 and blocking drum 170 in locking mechanism 116 provide low rolling friction interfaces that allow motor 168 to move locking mechanism 116 from the locked state to the unlocked state, and vice versa, using significantly less power than in prior art electric door strike assembly 10. For example, with reference to FIG. 12, the low rolling friction interfaces may be disposed between one or more of release trigger 132 and blocking member 186 at point 208, blocking member 186 and blocking drum 170 at point 206a, blocking drum 170 and blocking member 184 at point 206b, and blocking member 184 and back wall 112a of housing 112 at point 210. One or more of these low rolling friction interfaces allow motor 168 to move locking mechanism 116 from the locked state to the unlocked state using about 0.3 watts, whereas the solenoid used in prior art electric door strike assembly 10 may use about 6 watts to move between locked and unlocked states. This amounts to an energy savings of approximately 95% utilizing the aspects of the present invention when no preload is applied to electric door strike assembly 100.

Furthermore, as discussed above, prior art electric door strike assembly 10 is not able to move to an unlocked state when a preload force is imposed on the keeper arms 18. In accordance with an aspect of the present invention, locking mechanism 116 allows electric door strike assembly 110 to move from the locked state to the unlocked state when preload force 212 is imposed on keeper arm 118. This is due in part to the low rolling friction interfaces between blocking members 184, 186 and blocking drum 170 discussed above, but also because the transmission of preload force 218 (and resulting reaction force 222) being directed through axis of rotation 172 of blocking drum 170. The fact that the preload force 218 passes through axis of rotation 172 of blocking drum 170 negates any torque that may be imposed on blocking drum 170 by the preload force and allows motor 168 to rotate blocking drum 170 from the blocking position to the unblocking position without using significantly more energy to do so compared to a situation where no pre-load force is imposed. For instance, if a preload force of 5 pounds is imposed on keeper arm 118, control module 171 may only need to provide less than 1 watt of power to motor 168 to move blocking drum 170 from the blocking position to the unblocking position, and a preload force of 15 pounds may require less than 2 watts of power. This is a significant improvement over prior art electric door strike assembly 10 given that it is not even able to operate sufficiently when a preload is applied.

As can be seen from the examples above, control module 171 may be configured to adapt the amount of power that is provided to motor 168 and ultimately consumed by electric door strike assembly 100 based on the initial and future conditions in which electric door strike assembly 100 is operating under. Depending on the amount of preload force that is imposed on keeper arm 118, control module 171 is able to deliver a sufficient level of power to motor 168 to move blocking drum 170 between blocking and unblocking positions. For example, control module 171 may provide an increased amount of power to rotate blocking drum 170 as the preload force increases. Thus, the present design is able to dynamically adapt to varying amounts of pre-load being imposed on the electric strike, while at the same time utilize a fraction of the energy consumed by the solenoid in prior art electric door strike assembly 10.

In one exemplary method, the present invention may operate control module 171 to provide a first amount of power to actuator 168 based on a first force being applied to keeper arm 118 to move blocking drum 170 from the blocking position to the unblocking position to allow keeper arm 118 to move to the open position and removal of the latch from housing cavity 114 of electric strike 100. It should be understood that the first force being applied to keeper arm 118 may be zero or a force greater than zero being imposed by the latch on the inner surface of keeper arm 114 or by some other source. The exemplary method further includes operating control module 171 to provide a second amount of power to actuator 168 based on a second force applied to keeper arm 118 to move blocking drum 170 from the blocking position to the unblocking position to allow keeper arm 118 to move to the open position and removal of the latch from housing cavity 114 of electric strike 100. In one example, the first force may be zero (or non pre-load force) and the second force may be pre-load force 212. This method of operation allows control module 171 to dynamically change (e.g., increase) the amount of power delivered to actuator 168 depending on the amount pre-load force that is imposed on keeper arm 118 and/or the conditions upon which locking mechanism 116 is operating under. It is also contemplated that control module 171 provide one or more additional amounts of power to actuator 168 depending on the pre-load force being imposed on keeper arm 117. In other words, the present method being used in conjunction with locking mechanism 116 is able to adapt to different pre-load conditions while at the same use significantly less power compared to prior art electric strike 10.

In another exemplary embodiment, control module 171 may be configured to allow a user to select the amount of preload force that locking mechanism 116 is able to handle. For example, control module 171 may be configured sense and limit the amount of current that is provided to motor 168, wherein the selected current limit corresponds to a particular preload force value imposed on electric door strike assembly 100. The selected preload force can also correlate to a level of energy usage, wherein the energy usage or preload level could be selected by a user using a dip switch. For instance, if power source 8 is a battery disposed in housing 112, then a low power mode could be selected which would equate to a low preload capability.

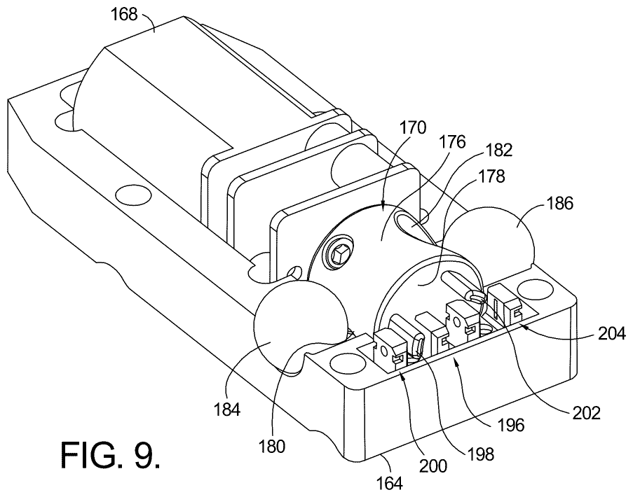

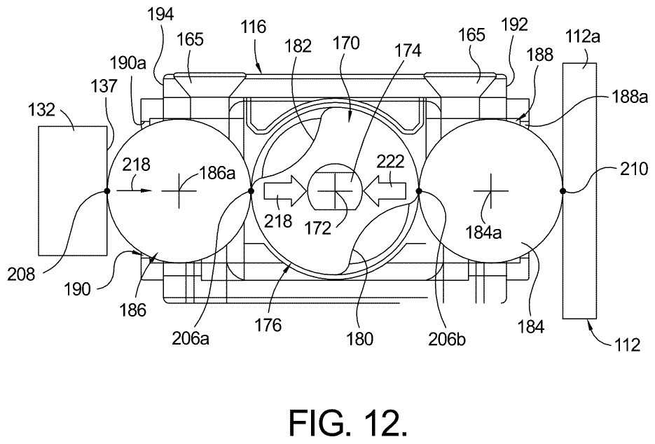

With reference to FIG. 13, an exemplary embodiment of a locking mechanism 250 that may be used as an alternative to locking mechanism 116 in electric door strike assembly 100 is provided. Locking mechanism 250 may include components and features that are the same as previously described above with respect to locking mechanism 116 and will not be repeated herein. However, instead of including two blocking members 184, 186 as is the case with locking mechanism 116, locking mechanism 250 includes only one blocking member 186 that is used in conjunction with blocking drum 170 to move electric door strike assembly 100 between the locked state and the unlocked state. As was the case with locking mechanism 116, preload force 218 imposed on blocking member 186 of locking mechanism 250 will pass through to blocking drum 170 via contact point 206a when blocking drum 170 is in the blocking position, and through axis of rotation 172. However, instead of the preload force 218 passing to rear wall 112a of housing 112 as is the case in locking mechanism 116, locking mechanism 250 operates to resist preload force 218 by at least one of shaft 174 (FIG. 8) of blocking drum 170 and/or interaction between outer surface 176 of blocking drum 170 and an inner wall 252 of casing 160. In another exemplary embodiment, body 160 of locking mechanism 250 may be modified so that outer surface 176 of blocking drum 170 (on the opposite side of blocking member 186) is disposed directly adjacent to rear wall 112a of housing 112 to resist preload force 218. It can be seen in FIG. 13 that recess 180 may be defined in outer surface 176 of blocking drum 170, but it should be understood that recess 180 may be omitted in locking mechanism 250 since blocking member 184 is not included therein.

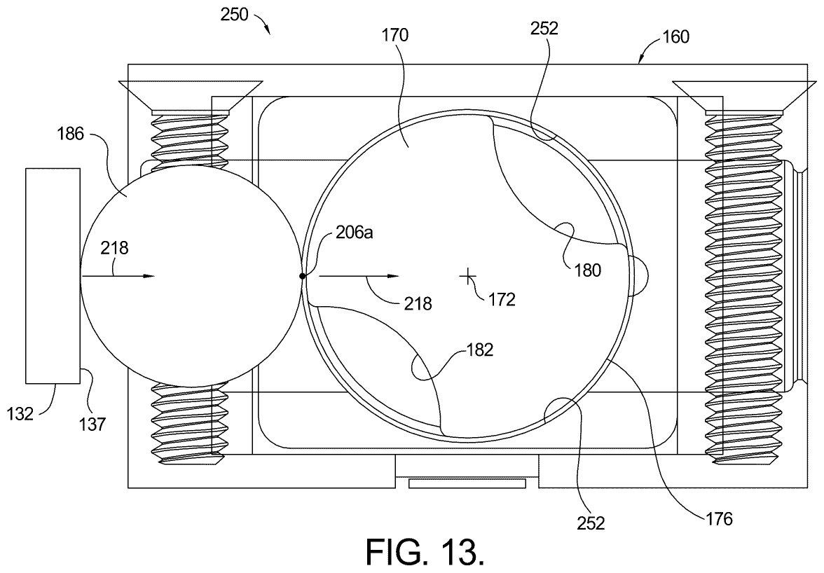

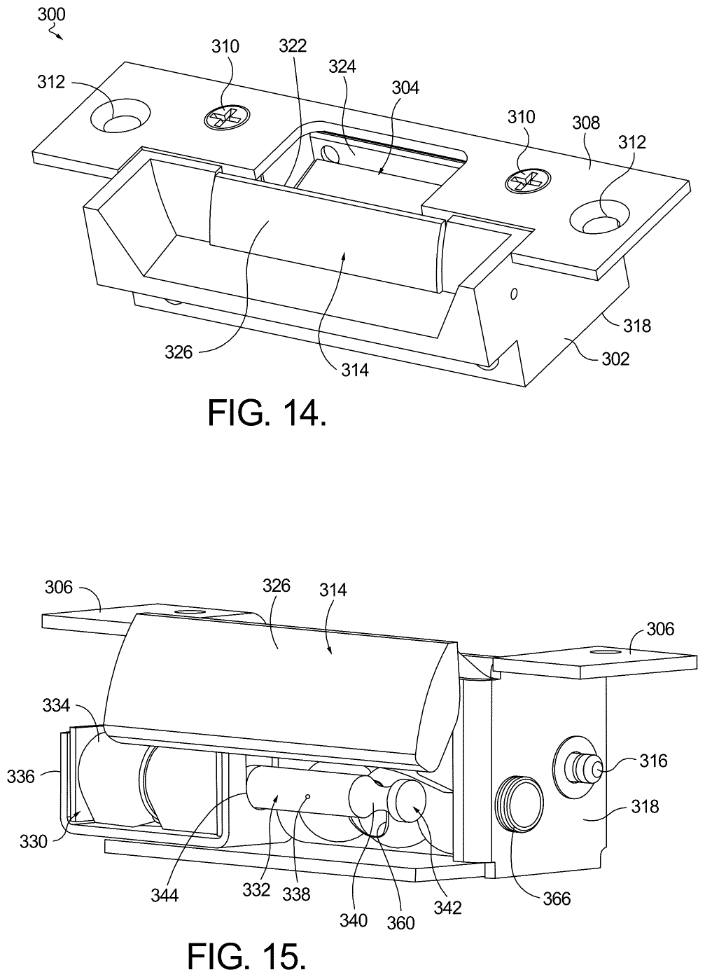

As generally shown in FIGS. 14-18C, a third embodiment of an electric door strike 300 in accordance with other aspects of the present invention is provided. With initial reference to FIG. 14, electric strike 300 includes a housing 302 defining a cavity 304 that is configured for receiving a latch of a lockset associated with door 2 when door 2 is in the closed position. As was discussed with respect to the previously discussed embodiments 100, 250, electric strike 300 may be operably connected to power source 8 and trigger device 9. Housing 302 may further include a pair of flanges 306 (FIG. 15) that are used to mount a face plate 308 using one or more fasteners 310. Face plate 308 in turn may be configured to include one or more apertures 312 that allow electric strike 300 to be mounted to door frame 4.

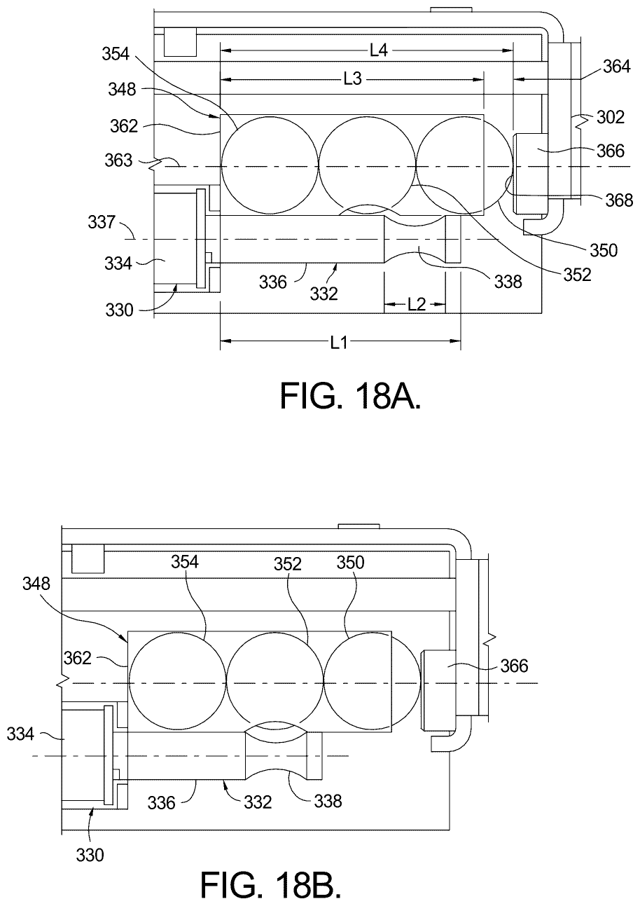

With additional reference to FIG. 15, electric strike 300 further includes a keeper 314 movably mounted to housing 302 between a latched position (FIGS. 14-17) to selectively retain the latch and door 2 in a closed position, and an unlatched position to allow the latch to be removed from cavity 304 so that door 2 may be opened. For example, keeper 314 may be rotatably mounted to housing 302 using a shaft 316 that extends between opposing side walls 318, 320 of housing 302. Keeper 314 includes an inner surface 322 disposed opposite of a rear wall 324 of housing 302 to define at least a portion of cavity 304. Keeper 314 further includes an outer ramp surface 326 that is configured for engaging and retracting the latch when door 2 is being moved to the closed position prior to the latch being disposed in cavity 304. As seen in FIG. 17, keeper 314 also includes a keeper stop feature 328 extending from inner surface 222 that will be described in further detail below in regard to the operation of electric strike 300.

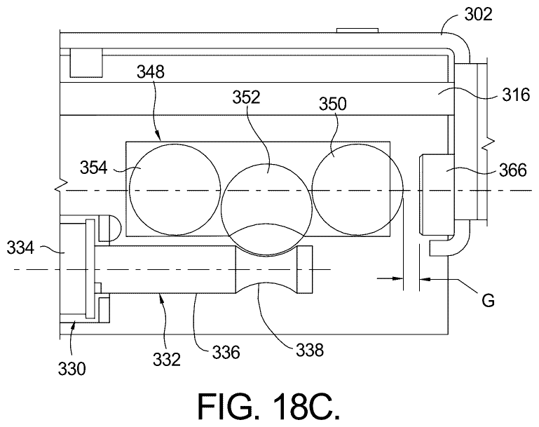

As best seen in FIG. 15, electric strike 300 further includes an actuator assembly 330 including a plunger 332 operably connected to an actuator 334. Actuator 334 may be, for example, a motor or a solenoid. Actuator 334 may be directly mounted to housing 302, or mounted to housing using a bracket 336. Actuator 334 operates to move plunger 332 between a first blocking position (FIGS. 15 and 18A) and a second unblocking position (FIGS. 18B-18C). Plunger 332 may have a length L1 that extends along an axis 337 (FIG. 18A), and include an outer surface 338 that has a recess 340 defined therein. For example, outer surface 338 of plunger 332 may be cylindrically-shaped with a first diameter, and recess 340 may be configured in a concave-shape that is radially carved into outer surface 338 resulting in a second diameter that is less than the first diameter. Recess 340 may extend a length L2 that makes up a portion of the length L1 of plunger 332. Further, recess 340 may be disposed between a first distal end 342 and a second end 344 of plunger 332.

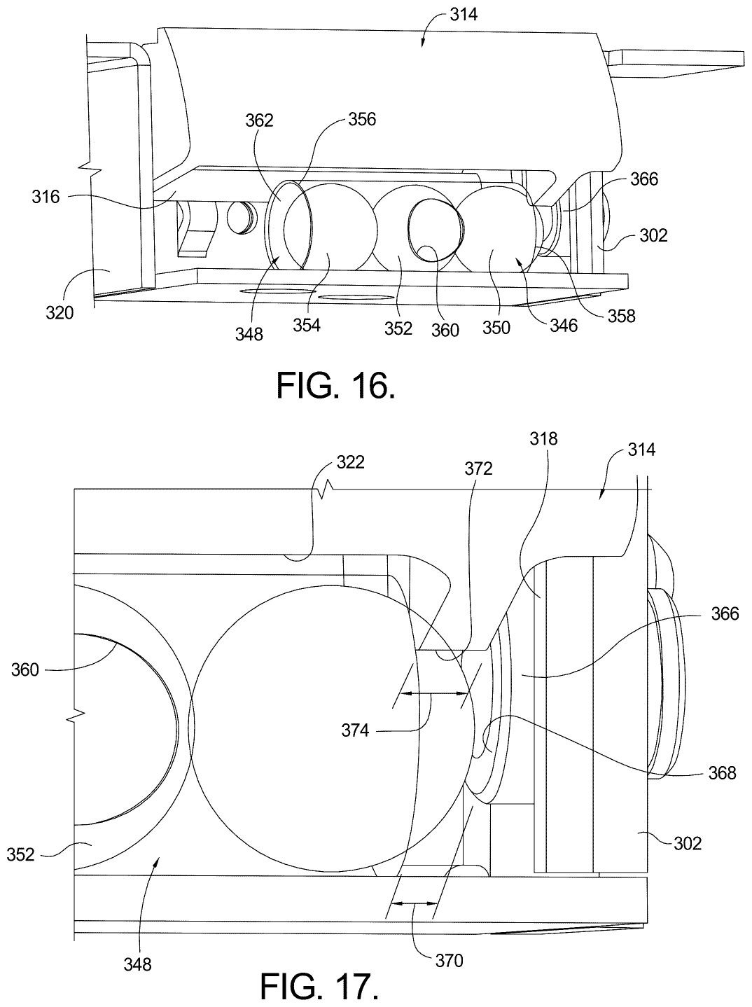

As best seen in FIGS. 15 and 16, electric strike 300 further includes a blocking assembly 346 positioned within housing 302 that operates in conjunction with actuator assembly 330 to selectively retain keeper 314 in the latched position. In one exemplary embodiment, blocking assembly 346 includes an enclosure 348 that is configured to contain at least one blocking member, such as a first blocking member 350, a second blocking member 352, and a third blocking member 354. For instance, blocking members 350, 352 and/or 354 may be ball bearings. In certain embodiments, enclosure 348 may be a tube-like structure having a length L3 defined between a first end 356 and a second end 358. Further, a cut-out portion 360 may be defined in enclosure 348 in a location between first and second ends 356, 358. Cut-out 360 may be positioned adjacent to second blocking member 352, for example, and be configured so that second blocking member 352 is not able to pass through cut-out portion 360.

With additional reference to FIG. 18A, first, second and third blocking members 350, 352, 354 may be aligned co-linearly in a side-by-side first orientation along an axis 363, and in contact with one another within enclosure 348 so that the total stack of blocking members has a total length L4. Axis 363 may be parallel with axis 337 of plunger 332. When blocking members are in the first orientation, at least a portion of first blocking member 350 extends beyond second end 358 of enclosure 348 a distance 364. In one exemplary embodiment, first end 356 of enclosure 340 may include an end wall 362, wherein third blocking member 354 may be in contact with end wall 362 and length L4 of the linear stack of blocking members is greater than length L3 of enclosure 348 in an amount equal to distance 364. Further, an adjustable stop 366 may be movably coupled to housing 302, and configured for extending into housing 302. Adjustable stop 366 may be adjusted relative to housing 302 so that a contact face 368 engages first blocking member 350 when in the first orientation. As such, first, second and third blocking members 350, 352, 354 may be engaged between adjustable stop 366 and end wall 362 with no gaps therebetween, or at least no material gaps therebetween. Further, when adjustable stop 366 engages first blocking member 350, second end 358 and contact face 368 are spaced apart a distance 370.

As mentioned above with respect to FIG. 17, keeper stop feature 328 extends from inner surface 222 of keeper 314. In particular, keeper stop feature 328 includes an engagement surface 372 that has a width 374 that is less than distance 370 so that at least a portion of keeper stop feature 328 is capable of sliding between second end 358 of enclosure 348 and engagement surface 372 when keeper 314 moves to the unlatched position. As will be described further below in conjunction with operation of electric strike 300, engagement surface 372 is configured to contact at least a portion of first blocking member 350 when blocking members 350, 352, 354 are in the first orientation shown in FIGS. 16 and 17, for example, to maintain keeper 314 in the latched position. It should be understood that in other exemplary embodiments, adjustable stop 366 could be eliminated, in which case, the description provided above with reference to distance 370 would apply to side wall 318 of housing 302.

The operation of electric strike 300 will now be described with respect to FIGS. 17 and 18A-18C. With initial reference to FIGS. 17 and 18A, electric strike 300 is in a position to maintain keeper 314 in a latched position to retain the latch in cavity 304 so that door 2 is not able to move out of door frame 4. In the latch position, plunger 332 is in the first blocking position so that at least a portion of outer surface 336 is disposed adjacent to cut-out 360. In the first blocking position, outer surface 336 prevents blocking member 352 from moving into cut-out portion 360 and thereby maintains blocking members 350, 352, 354 in the side-by-side first orientation shown in FIG. 18A. In this first orientation, keeper 314 is prevented from moving to the unlatched position through the interaction between engagement surface 372 on keeper stop feature 328 of keeper 314 and at least a portion of blocking member 350, as seen in FIG. 17. If an attempt is made to retract keeper 314 when plunger 332 and blocking members 350, 352, 354 are in the position shown in FIGS. 17 and 18A, keeper stop feature 328 would be positioned between second end 358 of enclosure 348 and contact face 368, and engage at least a portion of first blocking member 350. This force imposed on first blocking member 350 would thereafter be transmitted through the stack of blocking members 350, 352, 354 to first end 362 of enclosure 362. This configuration allows electric strike 300 to control a relative large pre-load on keeper 314 while minimizing the mechanical stress on the components of electric strike 300.

With reference to FIGS. 18B and 18C, electric strike 300 is also configured to allow keeper 314 to be moved an unlatched position so that the latch can be removed from cavity 304 and door 2 moved out of door frame 4. From the position shown in FIG. 18A, actuator 334 may be operated to move plunger 332 to the second unblocking position shown in FIG. 18B. Given the low friction contact interface between outer surface 336 of plunger 332 and second blocking member 352, it requires that actuator 334, such as a solenoid, provide a relatively low amount of power to move plunger 332 from the first blocking position (FIG. 18A) to second unblocking position (FIG. 18B), even when a significant amount of pre-load is imposed on keeper 314. When plunger 332 is moved to the second unblocking position, at least a portion of recess 338 is adjacent to, and optionally aligned with, cut-out 360 as seen in FIG. 18B. In the position shown in FIG. 18B, keeper 314 is then capable of moving to the unlatched position. When keeper 314 is moved to the unlatched position by imposing a force on inner surface 322 of keeper 314, keeper stop feature 328 is positioned between second end 358 of enclosure 348 and contact face 368, and engagement surface 372 contacts at least a portion of first blocking member 350. This causes the stack of blocking members 350, 352, 354 to collapse by moving at least a portion of second blocking member 352 into cut-out 360 and recess 338 as seen in FIG. 18C. The stack of blocking members 350, 352, 354 continues to collapse until a gap G is formed between first blocking member 350 and contact face 368 of adjustable stop 366, wherein the gap G is equal to or greater than width 374 of engagement surface 374 of keeper stop feature 328. This allows keeper stop feature 328 to pass between first blocking member 350 and contact face 368 thereby allowing keeper 314 to be placed in the unlatched position. A spring (not shown) may then be coupled with keeper 314 to bias keeper 314 back to the latched position after the latch is removed from cavity 304.

In order to move electric strike 300 from the unlatched position (FIG. 18C) to a state to retain keeper 314 in the latched position, actuator 334 is operated to move plunger 332 to the first blocking position shown in FIG. 18A. In one exemplary embodiment, recess 338 may be configured in a concave-shape that is radially carved into outer surface 338 of plunger 332. The concave shape of plunger 332 allows actuator 334 to move second blocking member 352 back into enclosure 348 using a relatively low amount of power as plunger 332 moves from second unblocking position to the first blocking position.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims. Furthermore, relative positional or directional terms used herein, such as for example, top, bottom, front, back, left side, right side, upward, downward, rightward, leftward, inward, outward, vertical, horizontal, clockwise, counterclockwise, etc., may have been used in the above-referenced description to describe a positional or directional relationship among elements as the elements are presented in the drawings. However, these terms should not limit in any way a specific orientation of the referenced feature, in practice. For example, a top wall as depicted in a drawing may be thought of as a side or bottom wall if the element is oriented differently in practice.

Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A locking mechanism for an electric strike for operating in conjunction with a latch of a lockset, the locking mechanism comprising:
an outer body including a first opening and a second opening defined therein, wherein the first opening includes a first distal edge, and wherein the second opening includes a second distal edge;
an actuator;
a blocking drum operably coupled to the actuator, wherein the blocking drum is selectively movable between a blocking position and an unblocking position by the actuator, wherein the blocking drum includes an outer surface, and wherein a first recess and a second recess are defined in the outer surface; and
a first blocking member movably disposed within the first opening;
a second blocking member movably disposed within the second opening; and
wherein when the actuator moves the blocking drum to the blocking position, the first blocking member and the second blocking member are engaged with the outer surface of the blocking drum, at least a portion of the first blocking member extends outwardly from the first distal edge of the first opening, and at least a portion of the second blocking member extends outwardly from the second distal edge of the second opening to place the electric strike in a locked position, and
wherein when the actuator moves the blocking drum to the unblocking position, at least a portion of the first blocking member is disposed within the first recess of the blocking drum, and at least a portion of the second blocking member is disposed within the second recess of the blocking drum to place the electric strike in an unlocked position.

2. The locking mechanism in accordance with claim 1, wherein the first recess and the second recess are defined on opposite sides of the outer surface of the blocking drum.

3. The locking mechanism in accordance with claim 1, wherein the blocking drum includes an axis of rotation, wherein the first blocking member is engaged with the outer surface of the blocking drum at a first contact point, wherein the second blocking member is engaged with the outer surface of the blocking drum at a second contact point, and wherein the first contact point, the axis of rotation, and the second contact point are co-linear.

4. The locking mechanism in accordance with claim 1, wherein the outer surface of the blocking drum is generally cylindrically-shaped.

5. The locking mechanism in accordance with claim 1, wherein the first blocking member and the second blocking member are ball bearings.

6. The locking mechanism in accordance with claim 5, wherein the first distal edge and the second distal edge are circular-shaped.

7. The locking mechanism in accordance with claim 6, wherein the first distal edge has a first diameter, wherein the first blocking member has a second diameter, and wherein the second diameter is greater than the first diameter.

8. The locking mechanism in accordance with claim 1, wherein the actuator is a gear motor.

9. The locking mechanism in accordance with claim 1, further comprising:
a control module in communication with the actuator, wherein the control module is configured for selectively controlling actuator to move the blocking drum between the blocking position and the unblocking position;
a first sensor configured for determining when the blocking drum is in the blocking position; and
a second sensor configured for determining when the blocking drum is in the unblocking position,
wherein control module controls the actuator to move the blocking drum from the unblocking position until the first sensor determines that the blocking drum is in the blocking position, and
wherein control module controls the actuator to move the blocking drum from the blocking position until the second sensor determines that the blocking drum is in the unblocking position.

10. The locking mechanism in accordance with claim 1, wherein the outer body includes a first piece and a second piece, wherein a first portion of the first opening and a first portion of the second opening are defined in the first piece, and wherein a second portion of the first opening and a second portion of the second opening are defined in the second piece.

11. An electric strike for operating in conjunction with a latch of a lockset, the electric strike comprising:
a) a housing including an inner wall, wherein the housing defines a housing cavity configured for receiving the latch;
b) at least one keeper arm mounted to the housing and movable between a closed position and an open position;
c) at least one transmission lever mounted to the housing and moveable between a latched position and an unlatched position;
d) at least one release trigger mounted to the housing and movable between an engaged position and a disengaged position; and
e) a locking mechanism comprising:
i) an outer body including a first opening and a second opening defined therein, wherein the first opening includes a first distal edge, and wherein the second opening includes a second distal edge;
ii) an actuator;
iii) a blocking drum operably coupled to the actuator, wherein the blocking drum is selectively movable between a blocking position and an unblocking position by the actuator, wherein the blocking drum includes an outer surface, and wherein a first recess and a second recess are defined in the outer surface; and
iv) a first blocking member movably disposed within the first opening;
v) a second blocking member movably disposed within the second opening; and
wherein when the actuator moves the blocking drum to the blocking position:
the first blocking member and the second blocking member are engaged with the outer surface of the blocking drum,
at least a portion of the first blocking member extends outwardly from the first distal edge of the first opening and engages the inner wall of the housing, and
at least a portion of the second blocking member extends outwardly from the second distal edge of the second opening and engages the at least one release trigger to maintain the at least one release trigger in the engaged position which in turn maintains the at least one transmission lever in the latched position and the at least one keeper in the closed position to retain the latch in the housing cavity; and
wherein when the actuator moves the blocking drum to the unblocking position:
at least a portion of the first blocking member is disposed within the first recess of the blocking drum, and at least a portion of the second blocking member is disposed within the second recess of the blocking drum, and
the at least one release trigger is permitted to move to the disengaged position and the at least one transmission lever is permitted to move to the unlatched position upon movement of the at least one keeper arm to the open position when the latch is moved out of the housing cavity.

12. The electric strike in accordance with claim 11, wherein the first recess and the second recess are defined on opposite sides of the outer surface of the blocking drum.

13. The electric strike in accordance with claim 11, wherein the blocking drum includes an axis of rotation, wherein the first blocking member is engaged with the outer surface of the blocking drum at a first contact point, wherein the second blocking member is engaged with the outer surface of the blocking drum at a second contact point, and wherein the first contact point, the axis of rotation, and the second contact point are co-linear.

14. The electric strike in accordance with claim 13, wherein the at least one release trigger includes a locking surface that is configured to engage the second blocking member at a third contact point, wherein the second contact point is co-planar with the first contact point, the axis of rotation, and the second contact point.

15. The electric strike in accordance with claim 14, wherein the at least one release trigger further includes a cam surface that is configured for engaging the second blocking member when the blocking drum is in the unblocking position.

16. The electric strike in accordance with claim 11, wherein the outer surface of the blocking drum is generally cylindrically-shaped.

17. The electric strike in accordance with claim 11, wherein the first blocking member and the second blocking member are ball bearings.

18. The locking mechanism in accordance with claim 17, wherein the first distal edge and the second distal edge are circular-shaped.

19. The electric strike in accordance with claim 18, wherein the first distal edge has a first diameter, wherein the first blocking member has a second diameter, and wherein the second diameter is greater than the first diameter.

20. The electric strike in accordance with claim 11, wherein the actuator is a gear motor.

21. The electric strike in accordance with claim 11, further comprising:
a control module in communication with the actuator, wherein the control module is configured for selectively controlling actuator to move the blocking drum between the blocking position and the unblocking position;
a first sensor configured for determining when the blocking drum is in the blocking position; and
a second sensor configured for determining when the blocking drum is in the unblocking position,
wherein control module controls the actuator to move the blocking drum from the unblocking position until the first sensor determines that the blocking drum is in the blocking position, and
wherein control module controls the actuator to move the blocking drum from the blocking position until the second sensor determines that the blocking drum is in the unblocking position.

22. The electric strike in accordance with claim 11, wherein the outer body includes a first piece and a second piece.

23. The electric strike in accordance with claim 22, wherein a first portion of the first opening and a first portion of the second opening are defined in the first piece, and wherein a second portion of the first opening and a second portion of the second opening are defined in the second piece.

24. The electric strike in accordance with claim 22, wherein at least one of the first piece and the second piece is integrally formed with the housing.

25. A method of operating an electric strike for use in conjunction with a latch of a locket, wherein the electric strike defines a cut-out configured for receiving the latch, and wherein the electric includes at least one keeper arm configured for being positioned in a closed position to selectively retain the latch in the housing cavity, wherein the method includes:
a) providing a locking mechanism comprising:
i) an actuator in electrical communication with a power source,
ii) a blocking drum operably coupled to the actuator, wherein the blocking drum is selectively movable by the actuator between a blocking position to maintain the at least one keeper arm in the closed position, and an unblocking position to allow the at least one keeper arm to move to an open position, wherein the blocking drum includes an outer surface, and wherein a first recess and a second recess are defined in the outer surface,
iii) a first blocking member configured for being in contact with the outer surface of the blocking drum when the blocking drum is in the blocking position, and disposed within the first recess when the blocking drum is in the unblocking position,
iv) a second blocking member configured for being in contact with the outer surface of the blocking drum when the blocking drum is in the blocking position, and disposed within the second recess when the blocking drum is in the unblocking position, and
b) providing a first amount of power to the actuator based on a first force applied to the at least one keeper arm to move the blocking drum from the blocking position to the unblocking position to allow the at least one keeper arm to move to the open position and removal of the latch from the housing cavity of the electric strike; and
c) providing a second amount of power to the actuator based on a second force applied to the at least one keeper arm to move the blocking drum from the blocking position to the unblocking position to allow the at least one keeper arm to move to the open position and removal of the latch from the housing cavity of the electric strike, wherein the second amount of power is greater than the first amount of power.

26. The method in accordance with claim 25, wherein the locking mechanism further comprises a control module in communication with the actuator, wherein the control module is configured for selectively controlling the first amount of power and the second amount of power provided to the actuator so that the blocking drum is able to be moved between the blocking position and the unblocking position.

27. The method in accordance with claim 25, wherein the second force is created by a pre-load force imposed on the at least one keeper arm by the latch disposed in the housing cavity of the electric strike.

28. The method in accordance with claim 27, wherein the first force is zero.

29-51 (canceled)
